(19) United States
(12) Patent Application Publication
(10) Pub. No.: US 2009/0253005 A1
(43) Pub. Date: Oct. 8, 2009

(54) REFORMER FOR A FUEL CELL

(75) Inventors: Marco Muehlner, Raduhn (DE); Andreas Lindermeir, Clausthal-Zellerfeld (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/721,748

(22) PCT Filed: Dec. 12, 2005
(86) PCT No.: PCT/DE2005/002242

§ 371 Date: Jun. 14, 2007

(30) Foreign Application Priority Data
Dec. 22, 2004 (DE) 10 2001 063 151.4

(51) Int. Cl. H01M 8/18

(52) U.S. Cl. 429/19

(57) ABSTRACT

A reformer (10) for a fuel cell has a chamber (26) including a chamber inlet (20) for the input of a reactant gas mixture and a chamber outlet (24) for the output of a reformed gas, a catalytic active medium being arranged in the chamber. The reformer (10) has a heat pipe (12) with an outer cylindrical pipe wall (14) and an inner cylindrical wall (16), the chamber (26) being disposed between the outer pipe wall (14) and the inner wall (16). Advantageously, the heat pipe has a passage with a helical shapes.

### BACKGROUND OF THE INVENTION

1. Field of the Invention

The invention relates to a reformer for a fuel cell comprising a chamber including a chamber inlet for the input of a reactant gas mixture and a chamber outlet for the output of a reformed gas, a catalytic active medium being arranged in the chamber.

2. Description of Related Art

Generic reformers have numerous fields of application, they particularly serving to supply a fuel cell with a hydrogen-rich gas mixture from which electrical energy can be generated on the basis of electrochemical reactions. Such fuel cells are utilized, for example, as auxiliary power units (APUs) in motor vehicles.

Reformer design is governed by a wealth of different factors. In addition to taking into account the properties of the reaction system, the economic embodiments are of importance, for example, particularly, also as regards integrating the reformer in its environment, the latter also involving how the inlet and outlet flow of material and energy in the reactor is handled. Thus, depending on the application and environment of the reformer, a variety of methods of reforming are applicable, as a result of which differing reformer structures are needed.

One example of a reforming process is the so-called catalytic reformer in which a mixture of air and fuel is converted with the aid of a catalytic active medium in an exothermic reaction into a hydrogen-rich reformate with which the fuel cell can be operated; this is catalytic partial oxidation (CPOX). In this catalytic conversion of the fuel/air mixture, the reaction can be divided into two different zones in the direction of flow. On entering the catalytic active medium, strongly exothermic oxidation reactions firstly take place, followed by the resulting intermediate products being reformed in a subsequent zone of the catalytically active medium. The reforming process is an endothermic reaction in which there is a pronounced drop in temperature, thus resulting in conversion losses.

In a CPOX reformer, the heat produced net in the inlet zone of the reformer is so high that damage to the materials involved may occur, for instance, the catalytic active medium may be deactivated or the substrate materials ruined. Because the reaction heat liberated by the oxidation zone cannot be brought into the reforming zone, controlling the reforming process becomes a problem so that, as a rule, there is no avoiding a polytropic handling of the reaction which, however, features a lesser degree of conversion.

### SUMMARY OF THE INVENTION

For a better conversion of the reactant gas mixture into the reformed gas, in accordance with the invention, the reformer comprises a heat pipe having an outer cylindrical pipe wall and an inner cylindrical defining wall, the chamber being disposed between the outer pipe wall and an inner defining wall.

The gist of the invention is to achieve, with the aid of a heat pipe including a fast heat transport, both a radial and an axial isothermic distribution of temperature in the catalytic active medium.

In one preferred embodiment, the chamber inlet is disposed near to a first axial end of a heat pipe and the chamber outlet near to a second axial end of the heat pipe so that the temperature can be compensated over as large as possible axial extent of the heat pipe.

It is particularly preferred to helically configure the chamber between the chamber inlet and chamber outlet, so that the small flow cross-sectional surface also minimizes the temperature gradients radially.

The invention will be explained in detail below by way of embodiment examples with reference to the accompanying drawings.

### BRIEF DESCRIPTION OF THE DRAWINGS

FIG. 1 is a cross-sectional view of a reformer in accordance with a first embodiment of the invention, FIG. 1a showing the details of the encircled area of FIG. 1,

FIG. 2 is a graph plotting the axial temperature profile in the reformer in the polytropic mode (broken line) and isothermic mode (solid line), and

FIG. 3 is a diagrammatic illustration of the fuel cell system including the reformer.

### DETAILED DESCRIPTION OF THE INVENTION

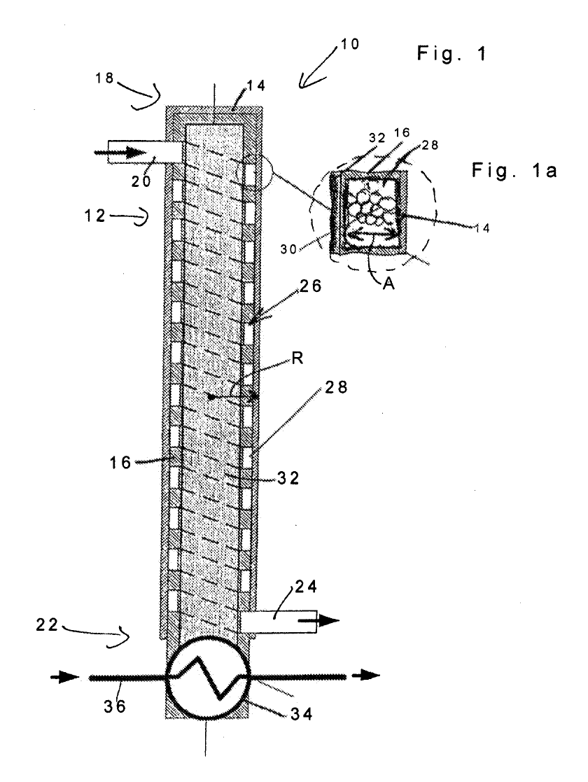

FIG. 1 shows a reformer 10 for a fuel cell system comprising a heat pipe 12 including an outer pipe wall 14 and an inner defining wall 16 both of which have a circular cylindrical shape. At a first axial end 18 of the heat pipe 12, there is provided a chamber inlet 20 through which a reactant gas mixture of, for example, air and evaporated fuel can enter the reformer. Disposed at a second axial end 22 of the heat pipe 12 is a chamber outlet 24 via which the reformed gas can exit the reformer 10. Outer pipe wall 14 and inner wall 16 define a chamber 26 extending between the chamber inlet 20 and chamber outlet 24. The chamber 26, in the embodiment as shown in this case, has a helical configuration between the chamber inlet 20 and chamber outlet 24. This is achieved by a passageway 28 being machined in the inner cylindrical wall 16. The dimension A of the passageway 28 in the radial direction of the heat pipe 12 is smaller than the radius R of the heat pipe 12. Arranged in the helical passageway 28 is a catalytic active medium 30 which, in this embodiment, is in the form of pellets (see, encircled of FIG. 1 shown in detail in FIG. 1a).

The passageway 28 machined in the inner wall 16 adds to the effective heat transfer surface between the catalytic active medium 30 and the inner defining wall 16 serving as the heat transport device, since a total of three contact surfaces are available for heat transport. The inner wall 16 encloses an inner chamber 32 having a filling of a liquid metal. Liquid metal fillings are highly suitable, particularly for temperatures ranging to 1100° C., preference being given to lithium or sodium. When using sodium as the liquid metal filling, there is the advantage that the inner wall 16 can be made of stainless steel.

A heat exchanger 34 is arranged in the region of the second axial end 22 of the heat pipe 12, by means of which thermal energy can be transported from heat pipe 12 to further system components of the fuel cell, especially to a liquid or gaseous medium flowing in a pipe 36, and from there, to the further system components. More details of this are given further on.

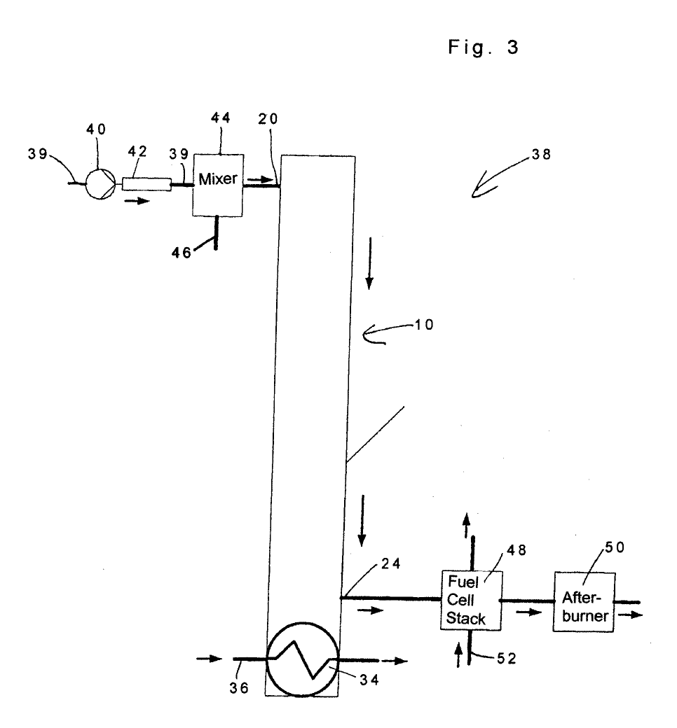

Referring now to FIG. 3, there is illustrated how the reformer 10 is married to a fuel cell system 38 by a fuel feed line 39 being connected to a media transport device 40 to which an evaporator 42 is connected. Fuel feed line 39 and an air feed line 46 are connected to a mixture formation device 44 which, in turn, is connected to the chamber inlet 20. Connecting the chamber outlet 24 of the reformer 10 is a fuel cell stack 48 followed by an afterburner 50. In addition to the connection to the chamber outlet 24 of the reformer 10 the fuel cell stack 48 also features a cathode air feed line 52.

The functioning of the reformer 10 of the fuel cell system 38 will now be explained as well as how the reformer 10 is included in the system as a whole.

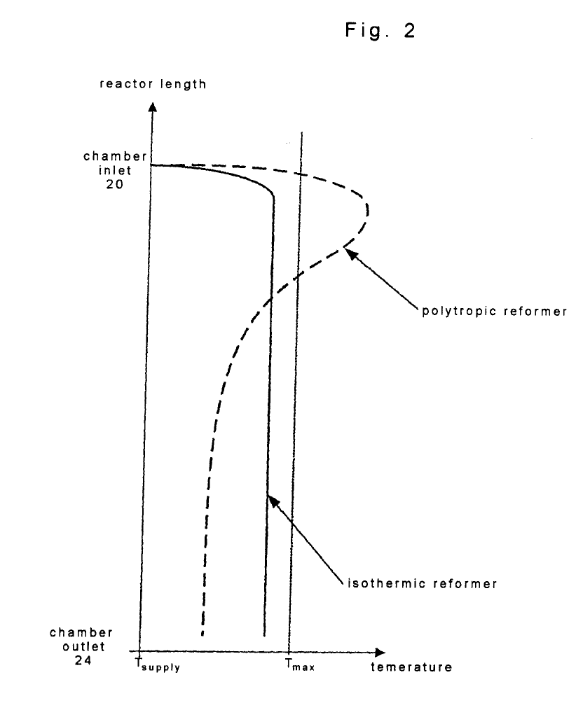

Via the fuel feed line 39, fuel is supplied by means of the media transport device 40 to the evaporator 42 where it is transformed into a gaseous phase. The evaporated fuel then flows into the mixture formation device 44 into which air is supplied by the air feed line 46 and is mixed with the evaporated fuel. The fuel/air mixture is then introduced via the chamber inlet 20 into the reformer 10 (FIG. 1), the fuel/air mixture then entering the catalytic active medium 30 which reforms the fuel/air mixture into intermediate products. The reaction heat liberated from the oxide reactions is transported by means of the heat pipe 12 to the filling of the inner chamber 32. Then, the reaction heat liberated in the region of the first axial end 18 of the heat pipe 12 is transported via the filling of the inner chamber 32 to the region of the second axial end 22 of the heat pipe 12. This is intended to avoid a hot spot at the first axial end 18 of the heat pipe 12 as is usual in a polytropic reaction mode (see FIG. 2, broken line curve) in achieving a practically constant temperature profile over the full axial extent of the heat pipe 12 (see FIG. 2, solid line curve). The intermediate products having materialized in the first axial end 18 of the heat pipe 12 are then transported in the passageway 28 in the region of the second axial end 22 of the heat pipe 12 where reforming of the intermediate products occurs. The transport of thermal energy in the inner chamber 32 from the first axial end 18 of the heat pipe 12 to the region of the second axial end 22 of the heat pipe 12 significantly adds to the shift in the thermodynamic equilibrium.

Referring now to FIG. 2, it can be seen how a hot spot is avoided at the first axial end 18 of the heat pipe 12 in the region of the chamber inlet 20 as occurs in a polytropic reaction mode in the prior art (see, FIG. 3, broken line curve) and by using the heat pipe 12 to attain a practically constant temperature profile over the full axial extent of the heat pipe 12 between the chamber inlet 20 and chamber outlet 24 (see, FIG. 2, solid line curve). The maximum temperature Tₘₐₓ which is not to be exceeded, so as not to reduce the life of the catalytic active medium and substrate materials, is not exceeded in any region of the heat pipe 12, thus safely excluding hot spots.

The reformed gas emerging at the chamber outlet 24 is then fed to the fuel cell stack 48 (see, FIG. 3) in which the electrical energy is released by known ways and means. The gases streaming from the fuel cell stack 48 are then directed to the afterburner 50 in which they are further exploited.

Since the fuel cell system 38 has, in all, an excess of thermal energy as a function of the mass flow of the reactant gas mixture at the chamber inlet 20, this can be made use of by means of the heat exchanger 34 for further system components of the fuel cell system 38. Such system components may be the mixture formation device 44, and the cathode air of the cathode air feed line 52 of the fuel cell stack 48. The pipe 36 of the heat exchanger 34 is then connected correspondingly to the air feed line 46 or cathode air feed line 52. The thermal energy from the heat exchanger 34 can also be supplied directly to a heating system in the case of a combined system for furnishing electrical energy and heat.

In addition to the isothermic temperature distribution in the heat pipe 12 as already discussed, controlling reforming is now significantly simplified in the reformer in accordance with the invention with enhanced modulating capacity as regards the material flows with a significant increase in the yield of reformed gas. Further, by making use of various catalytic active mediums in the passageway 28, handling of the reaction can be further optimized. By combining two reformers 10 via suitable piping and valves, utilizing and regenerating the two reformers can be alternated, i.e., when one of the two reformers is being regenerated, the other reformer can supply reformed gas for operating the fuel cell system 38 with a changeover after regeneration of the first reformer and depletion of the other so that the first reformer can then regenerate reformed gas for the fuel cell system 38. Where an even higher gas throughput is involved several reformers 10 can be operated in parallel, this also permitting use of various fuels available both in liquid and gaseous form.

1-9. (canceled)

10. A reformer for a fuel cell, comprising a chamber having a chamber inlet for the input of a reactant gas mixture and a chamber outlet for the output of a reformed gas, a catalytic active medium being arranged in the chamber, and a heat pipe having an outer cylindrical pipe wall and a inner cylindrical wall, said chamber being disposed between the outer pipe wall and the inner wall of the heat pipe.

11. The reformer for a fuel cell as set forth in claim 10, wherein the chamber inlet is disposed near a first axial end of the heat pipe and the chamber outlet is disposed near a second axial end of the heat pipe.

12. The reformer for a fuel cell as set forth in claim 11, wherein the chamber has a helical configuration between the chamber inlet and the chamber outlet.

13. The reformer for a fuel cell as set forth in claim 10, wherein the chamber has a helical configuration between the chamber inlet and the chamber outlet.

14. The reformer for a fuel cell as set forth in claim 10, wherein the chamber is formed by a passageway machined into the inner cylindrical wall.

15. The reformer for a fuel cell as set forth in claim 10, wherein the inner wall encloses an inner chamber, the inner chamber having a filling of liquid metal.

16. The reformer for a fuel cell as set forth in claim 15, wherein the liquid metal is one of sodium and lithium.

17. A fuel cell system comprising, a fuel cell and a reformer, the reformer having a chamber inlet for the input of a reactant gas mixture and a chamber outlet for the output of a reformed gas, a catalytic active medium being arranged in the chamber, and a heat pipe having an outer cylindrical pipe wall and a inner cylindrical wall, said chamber being disposed between the outer pipe wall and the inner wall of the heat pipe, and a heat exchanger arranged near the second axial end of the heat pipe, the heat exchanger being arranged to transport thermal energy from the heat pipe to system components of the fuel cell system.

18. The fuel cell system as set forth in claim 17, wherein the system components comprise a mixture formation device, and wherein the heat exchanger is arranged to transport the thermal energy from the heat pipe to the mixture formation device.

19. The fuel cell system as set forth in claim 17, wherein the system components comprise a supply of cathode air which is fed to the fuel cell and wherein the heat exchanger is arranged to transport thermal energy from the heat pipe to the cathode air.
